(19) United States
(12) Patent Application Publication
(10) Pub. No.: US 2015/0318948 A1
(43) Pub. Date: Nov. 5, 2015

(54) System and Method for Monitoring Filters in an Optical Add-Drop Multiplexer

(71) Applicant: TYCO ELECTRONICS SUBSEA COMMUNICATIONS LLC, Eatontown, NJ (US)

(72) Inventors: Franklin Webb Kerfoot, III, Red Bank, NJ (US); Lara Denise Garrett, Red Bank, NJ (US)

(21) Appl. No.: 14/698,798

(22) Filed: Apr. 28, 2015

Related U.S. Application Data
(60) Provisional application No. 61/987,823, filed on May 2, 2014.

(51) Int. Cl. H04J 14/02

(52) U.S. Cl. CPC H04J 14/0202

(57) ABSTRACT

A system and method for monitoring one or more filter configurations in an optical add-drop multiplexer for detecting faults in the filter configurations. A monitoring system is configured to filter the outputs of the filter configurations using one or more of a plurality of predetermined filter shapes corresponding to intended add, through, drop and/or branch through channels. The monitoring system detects power passing through the filter shapes to detect faults in the filter configurations.

### CROSS-REFERENCE TO RELATED APPLICATIONS

This application claims the benefit of the filing date of U.S. Provisional Application Ser. No. 61/987,823, filed May 2, 2014, the teachings of which are hereby incorporated herein in their entirety.

### TECHNICAL FIELD

The present disclosure relates to optical communication systems and in particular, to a system and method for monitoring filters in an optical add-drop multiplexer.

### BACKGROUND

To maximize the transmission capacity of an optical fiber transmission system, a single optical fiber may be used to carry multiple optical signals in what is called a wavelength division multiplexed system (hereinafter a WDM system). The multiple optical signals may be multiplexed to form a multiplexed signal or WDM signal with each of the multiple signals being modulated on separate wavelengths referred to as channels. Modern WDM systems have a high traffic capacity, for example, a capacity to carry up to 128 channels or more at up to 40 gigabits per second (hereinafter Gb/s) or more.

The optical fiber transmission system may include a relatively long trunk fiber segment that may be terminated at a transmitting and/or receiving trunk terminal. The optical fiber transmission system may further include one or more branching units situated along its trunk. Each branching unit (BU) may be connected to a branch fiber segment that terminates in a transmitting and/or receiving branch terminal. Each BU may include one or more optical add/drop multiplexers (OADM). Channels may be added to and/or dropped from the trunk fiber segment of the optical transmission system via the OADMs. The OADMs may also allow “through” channels or “express” channels on the trunk fiber segment to pass through the OADM without interruption.

The add/drop functionality of an OADM is facilitated by one or more filters. The transmission characteristics of the filters are set to match the add-drop and/or express channels for routing the channels to/from the trunk. If the filters fail, or the transmission characteristics of the filters drift or are otherwise misaligned relative to the add-drop and/or express channels, the OADM may fail to pass the proper channels to/from the trunk fiber.

### BRIEF DESCRIPTION OF THE DRAWINGS

Reference should be made to the following detailed description which should be read in conjunction with the following figures, wherein like numerals represent like parts.

FIG. 1 is a schematic illustration of an optical communication system consistent with the present disclosure.

FIG. 2 is a schematic diagram of a branching unit consistent with the present disclosure.

FIG. 3A is a waveform diagram illustrating a trunk monitor signal, an add channel filter shape and a through channel filter shape of a monitoring system consistent with the present disclosure.

FIG. 3B is a waveform diagram illustrating another trunk monitor signal with the add and through channel filter shapes illustrated FIG. 3A.

FIG. 3C is a waveform diagram illustrating a branch monitor signal, a drop channel filter shape and a branch through channel filter shape of a monitoring system consistent with the present disclosure.

FIG. 4 is a schematic diagram of one example of a monitoring system consistent with the present disclosure.

FIG. 5 is a waveform diagram illustrating a trunk monitor signal, an add channel filter shape, a through channel filter shape and first and second boundary channel filter shapes of a monitoring system consistent with the present disclosure.

FIG. 6 is a schematic illustration of another branching unit consistent with the present disclosure.

FIG. 7 is a schematic illustration of another branching unit consistent with the present disclosure.

FIG. 8 is a flowchart illustrating one example of a method consistent with the present disclosure.

### DETAILED DESCRIPTION

In general, the present disclosure provides a system and method for monitoring one or more filter configurations in an OADM for detecting faults in the filter configurations. Monitoring is performed using a monitoring system configured to filter the outputs of the filter configurations using one or more of a plurality of predetermined filter shapes corresponding to intended add, through, drop and/or branch through channels. The monitoring system detects power passing through the filter shapes to detect faults in the filter configurations.

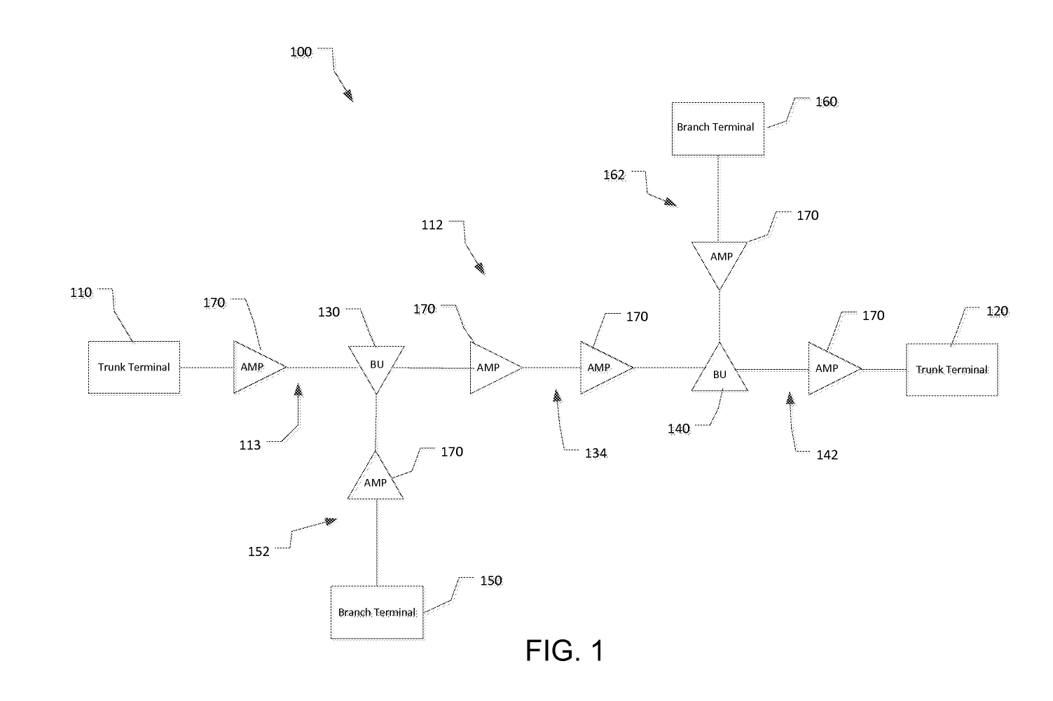

Turning now to FIG. 1, there is illustrated one example of an optical communication system 100 consistent with the present disclosure. The system 100 has been depicted in highly simplified form for ease of explanation. The optical communication system 100 includes trunk terminals 110 and 120 coupled to a trunk path 112. The term “coupled” as used herein refers to any connection, coupling, link or the like by which signals carried by one system element are imparted to the “coupled” element. Such “coupled” devices are not necessarily directly connected to one another and may be separated by intermediate components or devices that may manipulate or modify such signals.

The trunk path 112 may include a plurality of optical cable segments, e.g. cable segments 113,134,142, for carrying optical signals. Each cable segment may include one or more sections of optical fiber cable including optical fiber pairs and one or more repeaters 170 to provide a transmission path for bi-directional communication of optical signals between trunk terminal 110 and trunk terminal 120.

One or more branching units, e.g., branching units 130 and 140, may be coupled to the trunk path between the trunk terminals 110, 120. Each branching unit 130, 140 may be further coupled to a branch terminal, e.g., branch terminals 150 and 160, respectively, through an associated branch path 152, 162, respectively, perhaps through one or more repeaters 170 and linking optical cables. The system 100 may therefore be configured to provide bi-directional communication of optical signals between terminals 110, 120, 150 and/or 160 using the same trunk fiber pair, although multiple fiber pairs may be used and supported by each of the branching units 130, 140. For ease of explanation the description herein may refer to transmission from one terminal to another. It is to be understood, however, that the system 100 may be configured for bi-directional or unidirectional communication between any of the terminals 110, 120, 150 and/or 160.

The components in the trunk 112 and branch 152, 162 paths may include known configurations for achieving their intended functionality. The repeaters 170, for example, may include any known optical amplifier/repeater configuration that compensates for signal attenuation on the transmission path. For example, one or more of the repeaters 170 may be configured as an optical amplifier, such as an erbium doped fiber amplifier (EDFA), a Raman amplifier, or a hybrid Raman/EDFA amplifier. Also, one or more of the repeaters 170 may be provided in a known optical-electrical-optical configuration that regenerates an optical signal by converting it to an electrical signal, processing the electrical signal and then retransmitting the optical signal.

The system 100 may be configured as a long-haul system, e.g. having a length between at least two of the terminals 110, 120, 150, 150 of more than about 600 km, and may span a body of water. When used to span a body of water, e.g. an ocean, amplifiers 170 and/or branching units 130 and/or 140 may be seated on the ocean floor and the trunk path 112 path may span between beach landings. It will be appreciated that a plurality of repeaters, branching units and optical media links may be disposed beneath water and/or over land.

The system 100 is a wavelength division multiplexed (WDM) system capable of transmitting, carrying and receiving a WDM signal including a plurality of multiplexed optical signals modulated on a plurality of different wavelengths referred to as channels. An optical information signal may originate at one or more of the trunk terminals 110, 120 and/or one or more of the branch terminals 150, 160. Each branching unit 130, 140 may be configured to add and/or drop one or more information signals using, for example, an optical add/drop multiplexer (OADM). For example, a WDM trunk signal that originates at trunk terminal 110 may include one or more trunk signals that occupy one or more trunk channels on the trunk path 112. Likewise, a WDM branch signal that originates at branch terminal 150 may include one or more branch signals that occupy one or more branch channels on the branch path 152. Both WDM signals may be transmitted to a branching unit 130.

In general, the branching unit 130 is configured to extract one or more through channels originating from the trunk terminal 110 and destined for the other trunk terminal 120 from the WDM trunk signal and extract one or more add channels originating from the branch terminal 150 and combine the through channels and add channels into an aggregate WDM signal onto segment 134 of the trunk path 112. The branching unit 130 is also configured to extract one or more drop channels originating from the trunk terminal 110 and destined for the branch terminal 150 from the WDM trunk signal and extract one or more branch through channels originating from the branch terminal 150 and destined to be returned to the branch terminal 150 from the WDM branch signal and combine the drop channels and the branch through channels into an aggregate WDM signal on the branch path 152. Any of the add channels, drop channels, through channels or the branch through channels may have one or more information signals modulated on the wavelength corresponding to the channel or may be intentionally loaded with noise, e.g. ASE noise.

The branching unit 140 may similarly add and/or drop information signals. It will be appreciated that information signals that originate at terminal 120 and/or branch terminal 160 may be likewise added and/or dropped at branching unit 140 with a resulting optical signal transmitted to branching unit 130. The branching unit 130 may similarly add and/or drop information signals and pass a resulting optical signal to terminal 110.

Proper operation of a branching unit, such as the branching units 130 and 140, depends on the ability of the branching unit to reliably and accurately extract the add, drop, through and branch through channels from the WDM trunk and branch signals. Extraction of these channels is generally performed by filter configurations in the branching unit. If the filtering configurations fail or are misaligned with the channels, the channels may not be properly added or dropped by the branching unit.

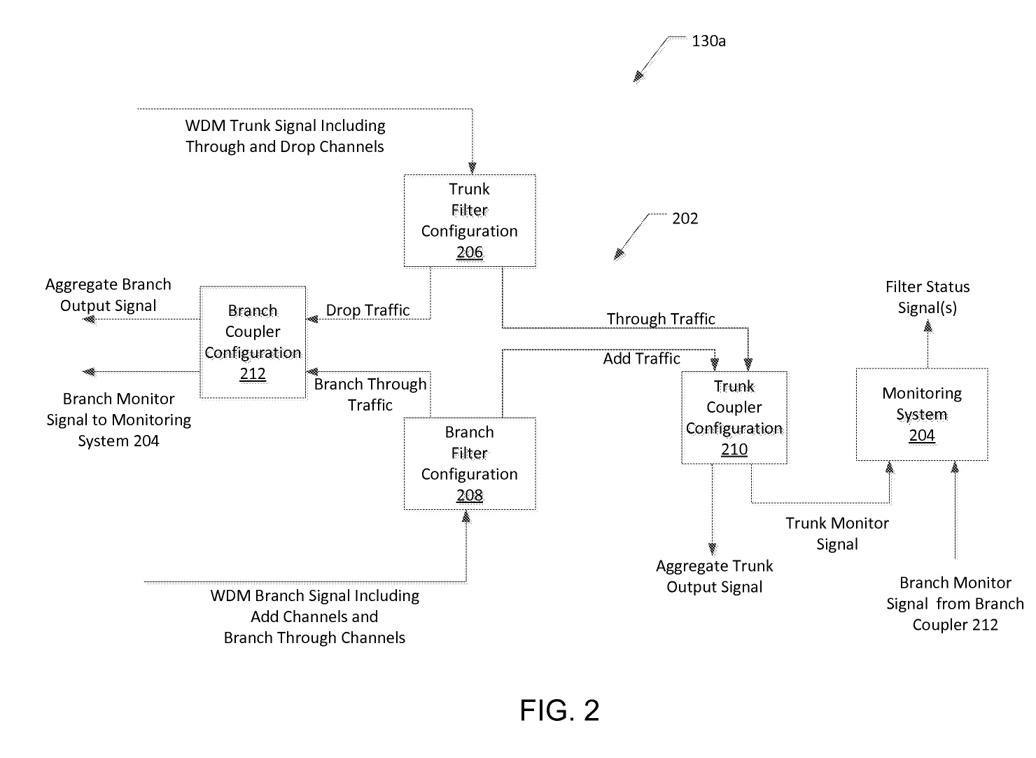

A system consistent with the present disclosure includes a monitoring system configured to monitor operation of the filter configurations in a branching unit and provide a filter status output indicating whether the filter configurations have failed or are misaligned with the channels intended to be added or dropped or passed through the branching unit. FIG. 2, for example, is a schematic diagram of one embodiment 130a of a branching unit consistent with the present disclosure. The illustrated embodiment includes an OADM 202 and a monitoring system 204. The OADM includes a trunk filter configuration 206, a branch filter configuration 208, a trunk coupler configuration 210 and a branch coupler configuration 212 and is shown in simplified form for ease of explanation. The monitoring system 204 monitors operation of the trunk and branch filter configurations 206, 208 and provides a filter status output if the trunk and/or branch filter configurations 206, 208 fail or are misaligned with the channels intended to be added, dropped or passed through the OADM 202.

In general, the trunk filter configuration 206 is configured to receive a WDM trunk signal including one or more through channels and one or more drop channels from the trunk path 112 (FIG. 1). The trunk filter configuration 206 is nominally configured to pass the drop channels onto a drop traffic path and block the through channels from the drop traffic path, and is nominally configured to pass the through channels to a through traffic path and block the drop channels from the through traffic path. The branch filter configuration 208 is configured to receive a WDM branch signal including one or more branch through channels and one or more add channels from the branch path 152 (FIG. 1). The branch filter configuration 208 is nominally configured to pass the add channels onto an add traffic path and block the branch through channels from the add traffic path, and is nominally configured to pass the branch through channels to a branch through traffic path and block the add channels from the branch through traffic path. As used herein, the term “nominally configured” when referring to a filter or filter configuration means the filter is intended to pass or drop the referenced signals, but may not actually pass the intended signals due to a fault or misalignment of the filter shape(s) in the filter or filter configuration.

A variety of trunk and branch filter configurations 206, 208 for passing the through channels, branch through channels, add and drop channels are known to those of ordinary skill in the art. For example, the trunk and branch filter configurations 206, 208 may be implemented as one or more known optical filter devices, e.g. fiber Bragg gratings, combined using other optical devices such as couplers or splitters. The trunk and/or branch filter configurations 206, 208 may alternatively be configured as reconfigurable optical filter configurations that allow adjustment of the filter shapes in response to a command signal, e.g. a remote command signal, to accommodate a change in the intended through, branch through, add or drop channels. For example, the trunk and/or branch filter configurations 206, 208 may be configured as wavelength selective switches (WSS). A WSS is a known device that switches optical signals to one or more outputs on a per-wavelength or channel basis. The wavelengths or channels switched to the outputs of a WSS may be established by a command signal provided to the WSS. Other examples of reconfigurable optical filter configurations are described in U.S. Pat. No. 8,401,392, the teachings of which are hereby incorporated herein by reference. Also, it is to be understood that, although FIG. 2 illustrates the trunk and branch filter configurations 206, 208 as discrete separate components, the trunk and branch filter configurations 206, 208 may share components or may be combined into a single component, such as a single WSS.

The trunk coupler configuration 210 is configured to combine the channels on the through traffic path and the channels on the add traffic path to provide an aggregate trunk output signal on the trunk path 112 (FIG. 1). The trunk coupler configuration 210 is also configured to provide a trunk monitor signal as an input to the monitoring system 204. The trunk monitor signal is representative of the optical spectrum of the aggregate trunk output signal. For example, the trunk path coupler configuration 210 may combine the channels on the through traffic path and the channels on the add traffic path to provide an aggregate signal and then provide a first portion of the aggregate signal as the aggregate trunk output signal and another portion of the aggregate signal as the trunk monitor signal.

The branch coupler configuration 212 is configured to combine the channels on the branch through traffic path and the channels on the drop traffic path to provide an aggregate branch output signal on the branch path 152 (FIG. 1). The branch coupler configuration 212 is also configured to provide a branch monitor signal as an input to the monitoring system 204. The branch monitor signal is representative of the optical spectrum of the aggregate branch output signal. For example, the branch path coupler configuration 212 may combine the channels on the branch through traffic path and the channels on the drop traffic path to provide an aggregate signal and then provide a first portion of the aggregate signal as the aggregate branch output signal and another portion of the aggregate signal as the branch monitor signal.

The trunk coupler configuration 210 and the branch coupler configuration 212 may be implemented using known components. For example, the trunk coupler configuration 210 may include a known wavelength combiner and a known coupler, e.g. a 10% optical coupler. The wavelength combiner may combine the channels on the through and add traffic paths into aggregate signal provide and aggregate signal to the coupler. The coupler may provide separate a portion of the aggregate signal to the monitoring system 204 as the trunk monitor signal and provide the remainder of the aggregate signal as the aggregate trunk output signal. The branch coupler configuration 212 may be configured in a similar manner.

In the illustrated embodiment, the monitoring system 204 monitors the trunk monitor signal and the branch monitor signal to determine whether the trunk filter configuration 206 and the branch filter configuration 208 have filtered the intended add, drop, through and branch through channels. Although the monitoring system 204 in FIG. 2 monitors both the trunk and branch filter configurations 206, 208, it is to be understood that a system consistent with the present disclosure may be configured to monitor only one of the trunk or branch filter configurations 206, 208. Also, the filter status output of the monitoring system 204 may be a single signal indicating status of one of the trunk or branch filter configurations 206, 208 or may include multiple signals, each of which may indicate the status of a different one of the trunk or branch filter configurations 206, 208, or a different portion of each of the trunk or branch filter configurations 206, 208.

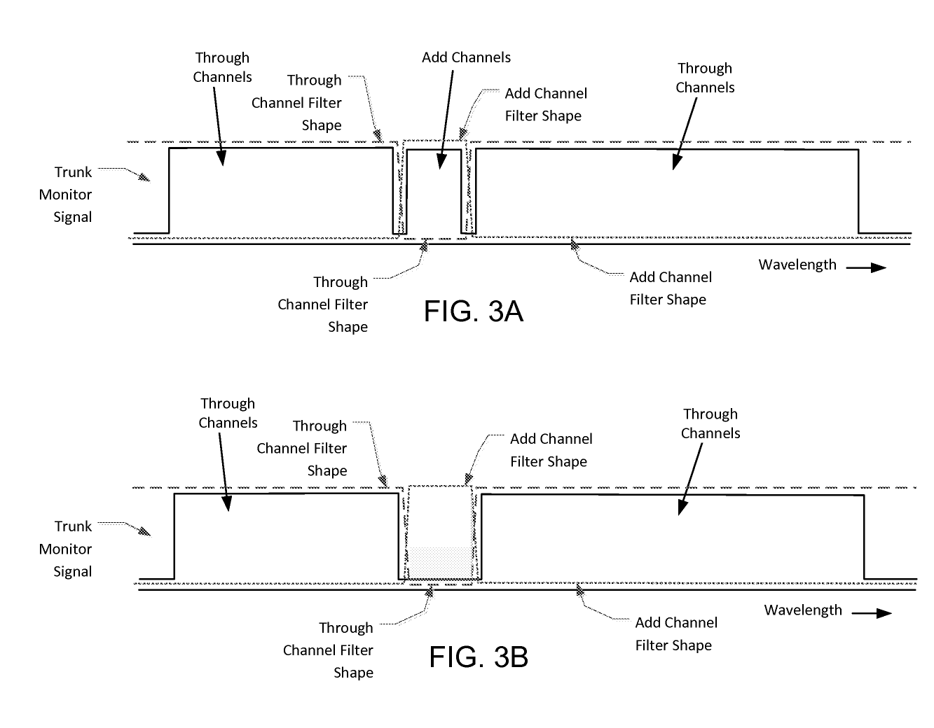

Advantageously, the monitoring system 204 monitors the trunk and branch filter configurations 206, 208 by filtering the trunk monitor signal and the branch monitor signals using a set of filter shapes corresponding to the intended add channels, drop channels, through channels and/or branch through channels and detecting power in the filtered signals. For example, FIG. 3A is a waveform diagram illustrating one example of the optical spectrum of a trunk monitor signal and filter shapes of the monitoring system 204 used to filter the trunk monitor signal.

As shown, the trunk monitor signal includes a band of add channels that passed through the branch filter configuration 208. The add channels are disposed between two bands of through channels that passed through the trunk filter configuration 206. The monitor system 204 filters the trunk monitor signal using an add channel filter shape and a through channel filter shape. The add channel filter shape is configured to pass the add channels that are intended to be added by the OADM 202 from the branch path through the branch filter configuration 208 and block the through channels from the trunk path that are intended to be passed through the OADM and the trunk filter configuration 206. The through channel filter shape is configured to pass the through channels from the trunk path that are intended to be passed through the OADM 202 and the trunk filter configuration 206 and block the add channels that are intended to be added by the OADM from the branch path and pass through the branch filter configuration 208.

The monitoring system 204 is configured to detect the amount of optical power passed by each of the filter shapes established by the monitoring system 204, e.g. the through channel filter shape and the add channel filter shape in the embodiment of FIG. 3A. If the amount of optical power passing through any of the filter shapes is different, e.g. ±20%, from a pre-determined expected amount of power, then a fault exists in the trunk or branch filter configuration 206, 208, or the trunk or branch couplers 210, 212. For example, the add channel filter shape of the branch filter configuration 208 or the through channel filter shape of the trunk filter configuration 206 may be misaligned with the add or through channels, or the trunk or branch filter configuration 206, 208 may have failed resulting in no channels passing to the trunk path.

In the embodiment illustrated in FIG. 3A, the add channels in the trunk monitor signal are aligned with the add channel filter shape of the monitoring system 204, and the through channels in the trunk monitor signal are aligned with the through channel filter shape of the monitoring system 204. In the illustrated embodiment, therefore, the monitoring system 204 will detect the predetermined expected amount of optical power passing through the add channel filter shape and the through channel filter shape, indicating that the trunk and branch filter configuration 206, 208 are operating properly with respect to the intended add and through channels.

FIG. 3B, however, is a waveform diagram illustrating the same filter shapes as in FIG. 3A, but with a trunk monitor signal having power in the add channels significantly reduced compared to add channels in the trunk monitor signal shown in FIG. 3A. In the configuration of FIG. 3B, the monitoring system 204 will not detect the predetermined expected amount of optical power passing through the add channel filter shape, indicating a fault in the add channel filter shape of the branch filter configuration 208. In the illustrated embodiment, for example, the add channel filter shape of the branch filter configuration 208 may have failed in an opaque state, i.e. no add channels were passed through the branch filter configuration 208. This fault may be indicated by the fault status output (FIG. 2) of the monitoring system 204.

The monitoring system 204 may monitor only the trunk filter configuration 206, only the branch filter configuration 208, or only portions of the trunk and branch filter configurations 206, 208 (e.g. only the add filter shape or through filter shape of the trunk filter configuration.) FIG. 3C, for example, is a waveform diagram illustrating one example of the optical spectrum of a branch monitor signal and filter shapes of the monitoring system 204 used to filter the branch monitor signal. As shown, the branch monitor signal includes a band of drop channels that are passed by the trunk filter configuration 206. The drop channels are disposed between two bands of branch through channels that passed through the branch filter configuration 208. The monitoring system 204 filters the branch monitor signal using a drop channel filter shape and a branch through channel filter shape. The drop channel filter shape is configured to pass the drop channels that are intended to be dropped by the OADM 202 from the trunk path through the trunk filter configuration 206 and block the branch through channels from the branch path that are intended to be passed through the OADM and the branch filter configuration 208. The branch through channel filter shape is configured to pass the branch through channels from the branch path that are intended to be passed through the OADM 202 and the branch filter configuration 208 and block the drop channels that are intended to be dropped by the OADM 202 from the trunk path and pass through the trunk filter configuration 206.

In the embodiment illustrated in FIG. 3C, the drop channels in the branch monitor signal are aligned with the drop channel filter shape of the monitoring system 204, and the branch through channels in the branch monitor signal are aligned with the branch through channel filter shape of the monitoring system 204. In the illustrated embodiment, therefore, the monitoring system 204 will detect the predetermined expected amount of optical power passing through the drop channel filter shape and the branch through channel filter shape, indicating that the trunk and branch filter configurations 206, 208 are operating properly with respect to the drop and branch through channels.

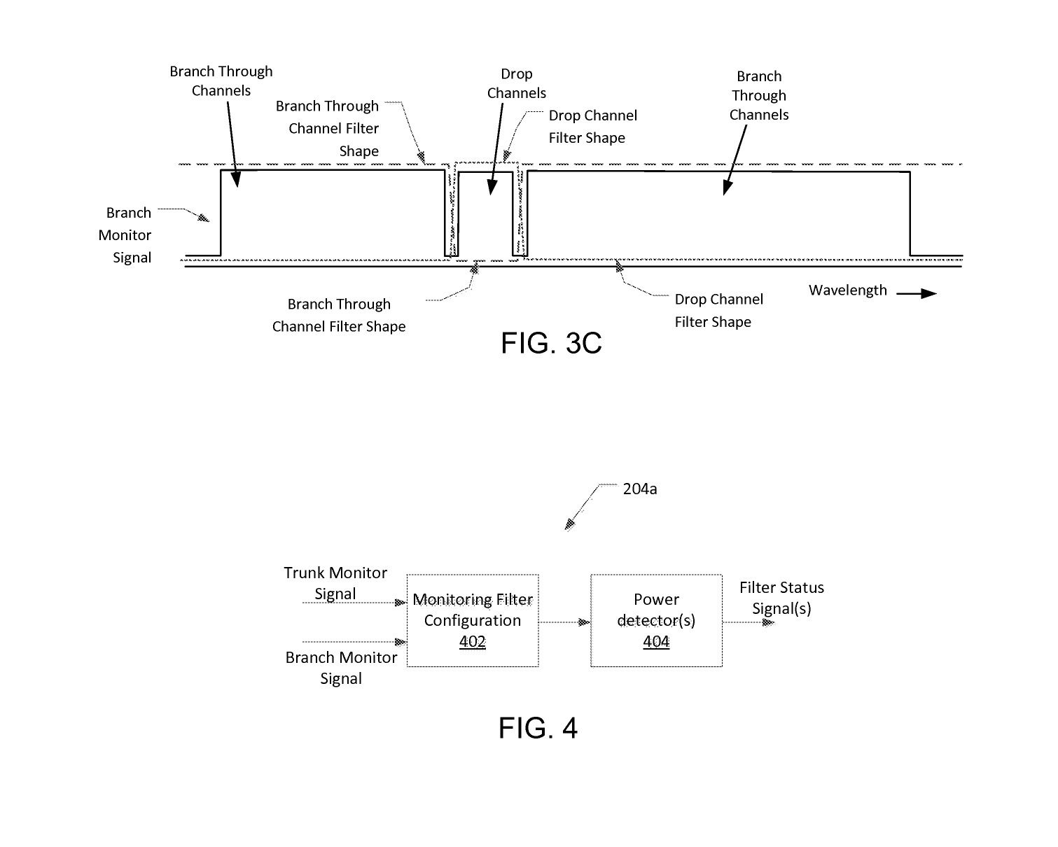

A monitoring system consistent with the present disclosure may be implemented in any configuration for applying the monitoring system filter shapes and detecting power in the signals passed by the filter shapes. One embodiment 204a of a monitoring system consistent with the present disclosure is illustrated in FIG. 4. In the illustrated embodiment, the monitoring system 204a includes monitoring filter configuration 402 and one or more power detector(s) 404.

The monitoring filter configuration 402 may be implemented as one or more known optical filter devices, e.g. fiber Bragg gratings, combined using other optical devices such as couplers or splitters, or may be configured as reconfigurable optical filter configuration that allow adjustment of the monitoring system 204a filter shapes in response to a command signal, e.g. to accommodate a change in intended through, branch through, add or drop channels. For example, the monitoring filter configuration 402 may be configured as one or more wavelength selective switches (WSS).

The power detectors 404 may include one or more broadband photodetectors configured to detect optical power passed through the filter shapes established by the monitoring filter configuration 402. A single power detector may be coupled for detecting the optical power passed through each of the filter shapes, or separate power detectors may be coupled for detecting optical power passed through associated ones of the filter shapes. The output(s) of the power detectors 404 may be provided as the filter status signals(s) of the monitoring system 204a.

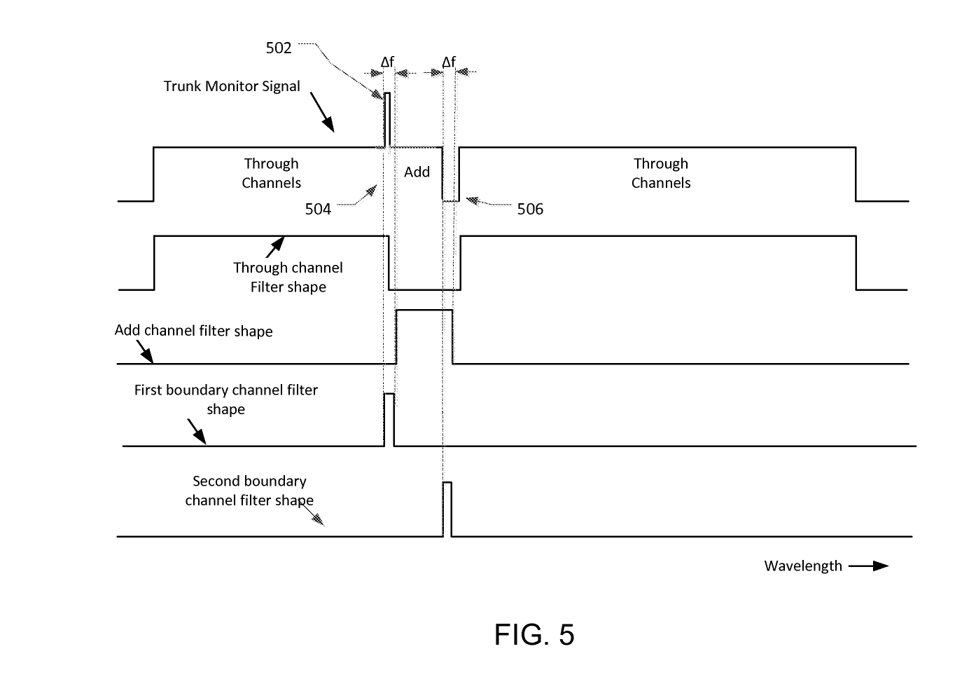

In a system consistent with the present disclosure, the trunk and branch filter configurations may pass add, through, drop and/or branch through channels that are offset compared to the intended add, through, drop and/or branch through channels only by a relatively small amount. FIG. 5, for example, illustrates a trunk monitor signal including a small frequency offset Δf between the intended add channels and the add channels in the trunk monitor signal. This small frequency offset Δf results in a higher optical power being transmitted in a portion 502 of the trunk monitor signal where the add and through channels overlap. Depending on the amount of the frequency offset Δf, a monitoring system including only add and through channel filter shapes may pass the predetermined expected amount of optical power associated with the add and through channel filter shapes. As a result, the monitoring system may not detect a fault in the alignment of the OADM trunk and branch filter configurations 206, 208.

To detect small frequency offsets in the add channels, through channels, drop channels and/or branch through channels compared to the intended add, through, drop and/or branch through channels, respectively, a monitoring system consistent with the present disclosure may include boundary channel filter shapes. In general, the boundary channel filter shape(s) may be configured to pass channels only in the boundary(s) between the intended add and through channels and/or the intended drop and branch through channels, while blocking other channels. The optical power passed by the boundary channel filter shapes changes substantially with small frequency offsets. The monitoring system may detect the optical power passed by the boundary filter shape(s) and provide an output indicating a fault in the trunk and/or branch filter configurations if the optical power passed by the boundary filter shape(s) does not meet a predetermined expected amount of optical power.

FIG. 5, for example, includes waveform diagrams illustrating an add channel filter shape, a through channel filter shape and first and second boundary channel filter shapes for a monitoring system 204 consistent with the present disclosure. The add channel filter shape and the through channel filter shape may configured as described above in connection with FIGS. 3A and 3B. In particular, the add channel filter shape is configured to pass the add channels that are intended to be added by the OADM 202 from the branch path through the branch filter configuration 208 and block the through channels from the trunk path that are intended to be passed through the OADM and the trunk filter configuration 206. The through channel filter shape is configured to pass the through channels from the trunk path that are intended to be passed through the OADM 202 and the trunk filter configuration 206 and block the add channels that are intended to be added by the OADM from the branch path and pass through the branch filter configuration 208. When the monitoring system 204 detects that the amount of optical power passing through the add or through channel filter shape is different, e.g. ±20%, from a pre-determined expected amount of power, then a fault exists in the trunk or branch filter configuration 206, 208, or the trunk or branch couplers 210, 212.

The first boundary channel filter shape is configured to pass boundary channels at a first boundary 504 between the through channels and the add channels and to block all other channels. The boundary channels passed by the first boundary channel filter shape may, for example, include a portion of the through channels that are intended to be passed through trunk filter configuration 206 and a portion of the add channels that are intended passed through the branch filter 208 configuration at the first boundary 504. The second boundary channel filter shape is configured to pass boundary channels at a second boundary 506 between the through channels and the add channels and to block all other channels. The boundary channels passed by the second boundary channel filter shape may, for example, include a portion of the through channels that are intended to be passed through trunk filter configuration 206 and a portion of the add channels that are intended passed through the branch filter 208 configuration at the second boundary 506. When the monitoring system 204 detects that the amount of optical power passing through the first and/or second boundary channel filter shapes is different, e.g. ±20%, from a pre-determined expected amount of power associated with the first and second boundary channel filter shapes, then a fault exists in the trunk or branch filter configuration 206, 208, or the trunk or branch couplers 210, 212.

In the configuration shown in FIG. 5, for example, the monitoring system may pass the predetermined expected amount of optical power through the add channel filter shape and the through channel filter shape, i.e. depending upon the setting for the predetermined expected amount of power for the add and through channel filter shapes. However, the first boundary channel filter shape would pass an amount of optical power that is greater than a predetermined amount of optical power associated with the first boundary channel filter shape, and the second boundary channel filter shape may pass an amount of optical power that is less than a predetermined amount of optical power associated with the second boundary channel filter shape, indicating that the add channels are misaligned relative to the intended add channels in the direction of the first boundary 504, i.e. to the left in FIG. 5. This fault may be indicated by one or more of the filter status signal(s) (FIG. 2) of the monitoring system 204.

If, however, the add channels in the trunk monitor signal were misaligned relative to the intended add channels in the direction of the second boundary 506, i.e. to the right in FIG. 5, the first boundary channel filter shape may pass an amount of optical power that is less than a predetermined amount of optical power associated with the first boundary channel filter shape, and the second boundary channel filter shape would pass an amount of optical power that is greater than a predetermined amount of optical power associated with the second boundary channel filter shape. In response to the optical power passed by the boundary channel filter shapes, therefore, the filter status output(s) of the monitoring system may indicate the direction of misalignment of the add channels. In response to the filter status output(s), the filter configurations may be reconfigured to pass the intended add channels.

A monitoring system consistent with the present disclosure may include any number of predetermined filter shapes specifically configured for filtering the intended add, through, branch and/or branch through channels, and/or the boundaries therebetween. For example, boundary filter channel shapes may be provided for filtering the trunk and/or branch monitor signals at all of the boundaries between the intended add and through channels and/or the intended drop and branch through channels in a system consistent with the present disclosure. Also, one or more of the boundaries between the intended add and through channels and/or the intended drop and branch through channels may be filtered in the monitoring system by multiple associated boundary filters to provide increased sensitivity to misalignment of the channels toward the boundaries. For example, the first and/or second boundary filter shapes in FIG. 5 may be replaced by multiple associated first and/or second boundary filter shapes.

Advantageously, therefore, a monitoring system 204 consistent with the present disclosure may apply a predetermined set of filter shapes corresponding to add, drop, through, branch through and/or boundary channels for detecting faults in the trunk and branch filter configurations of an OADM. Because the number of filter shapes is limited, the monitoring system 204 may be configured to rapidly apply the filter shapes to the trunk and/or branch monitor signal, e.g. sequentially, to monitor operation of the branch and trunk and filter configurations. This would require significantly less time than, for example, sweeping a fixed narrow filter across the entire spectrum of the trunk or branch monitor signal in discrete, successive steps to determine power in the spectrum. A system and method consistent with the present disclosure thus allows rapid detection of filter failures in an OADM.

The filter status signals output by the monitoring system 204 in a system consistent with the present disclosure indicate a failure of the trunk 206 and/or branch 208 filter configurations and may be provided to an element management system (EMS) and/or network management system (NMS) to alert system administrators of the fault. In response, the EMS, NMS or system administrators may take corrective and/or recovery action. For example, in response to the filter status signals, a command may be sent, e.g. through the NMS, to the trunk 206 and/or branch 208 filter configurations to adjust the filter shapes of the trunk 206 and/or branch 208 filter configurations to filter the intended add, through, drop or branch through channels.

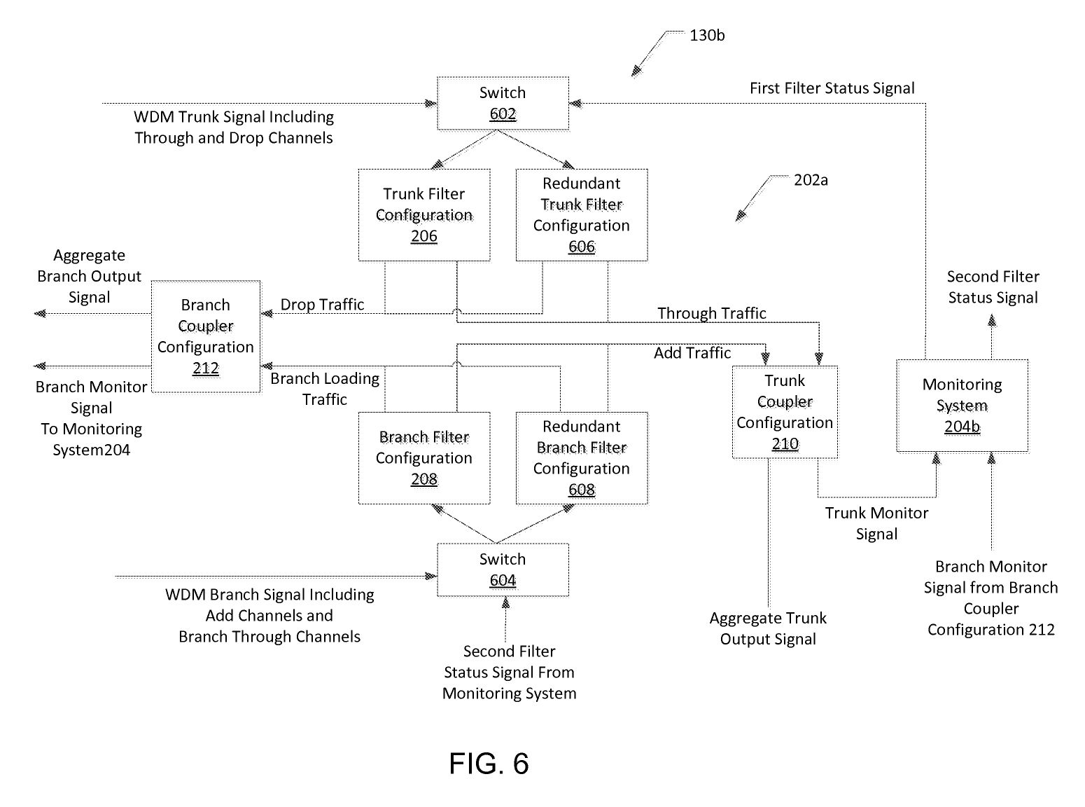

In addition, or alternatively, a system consistent with the present disclosure may be configured to switch to redundant trunk and/or branch filter configurations in response to a fault indicated by the filter status signal(s) of the monitoring system. FIG. 6, for example, is a schematic diagram of an embodiment 130b of a branching unit consistent with the present disclosure including an OADM 202a and a monitoring system 204b. The OADM 202a includes a trunk filter configuration 206, a redundant trunk filter configuration 606, a first switch 602, a branch filter configuration 208, a redundant branch filter configuration 608, a second switch 604, a trunk coupler configuration 210 and a branch coupler configuration 212.

In general, the trunk filter configuration 206, branch filter configuration 208, trunk coupler configuration 210 and branch coupler configuration 212 may be configured and operate as described above in connection with FIG. 2. The redundant trunk filter configuration 606 may duplicate the functionality of the trunk filter configuration 206 and may be configured and connected to the trunk 210 and branch 212 coupler configurations in the same manner as the trunk filter configuration 206. The redundant branch filter configuration 608 may duplicate the functionality of the branch filter configuration 208 and may be configured and connected to the trunk 210 and branch 212 coupler configurations in the same manner as the branch filter configuration 208. The monitoring system 204b monitors trunk and branch monitor signals, as described above in connection with FIGS. 2-5 and is configured to provide a first filter status signal to the first switch 602 and a second filter status signal to the second switch 604.

The first switch 602 is configured to receive the WDM trunk signal and has a first state for routing the WDM trunk signal to the trunk filter configuration 206 and a second state for routing the WDM trunk signal to the redundant trunk filter configuration 606. The first switch 602 is configured to change between the first state and the second state in response to the first filter status signal from the monitoring system 204b. The second switch 604 is configured to receive the WDM branch signal and has a first state for routing the WDM branch signal to the branch filter configuration 208 and a second state for routing the WDM branch signal to the redundant branch filter configuration 608. The second switch 604 is configured to change between the first state and the second state in response to the second filter status signal from the monitoring system 204b.

Initially, the first and second filter status signals from the monitoring system 204b may indicate that there is no fault in the alignment of the filters of the trunk 206 and branch 208 filter configurations relative to the intended add, through, drop and branch through channels. When there is no fault in the trunk 206 and branch 208 filter configurations, the first switch 602 is maintained in the first state to route the WDM trunk signal to the trunk filter configuration 206 and the second switch 604 is maintained in the first state to route the WDM branch signal to the branch filter configuration 208. However, if there is a fault in the alignment of the filters of the trunk 206 and/or branch 208 filter configurations relative to the intended add, through, drop or branch through channels, the fault will be indicated by the first and/or second filter status signals of the monitoring system 204b, e.g. as discussed above in connection with FIGS. 2-5. In response to a fault indicated by the first or second filter status signals, the first 602 or second 604 switches, respectively, may change to the second state.

Advantageously, such a configuration allows for rapid recovery from a failed trunk 206 and/or branch 208 filter configurations. For example, if the add channel filter shape of the branch filter configuration 208 fails in an opaque state, as shown in FIG. 3B, the monitoring system 204b will not detect the predetermined expected amount of optical power passing through the add channel filter shape, indicating a fault in the add channel filter shape of the branch filter configuration 208. In response, the monitoring system 204b may provide a second filter status signal configured to change the state of the second switch 604 to the second state to route the WDM branch signal to the redundant branch filter configuration 608.

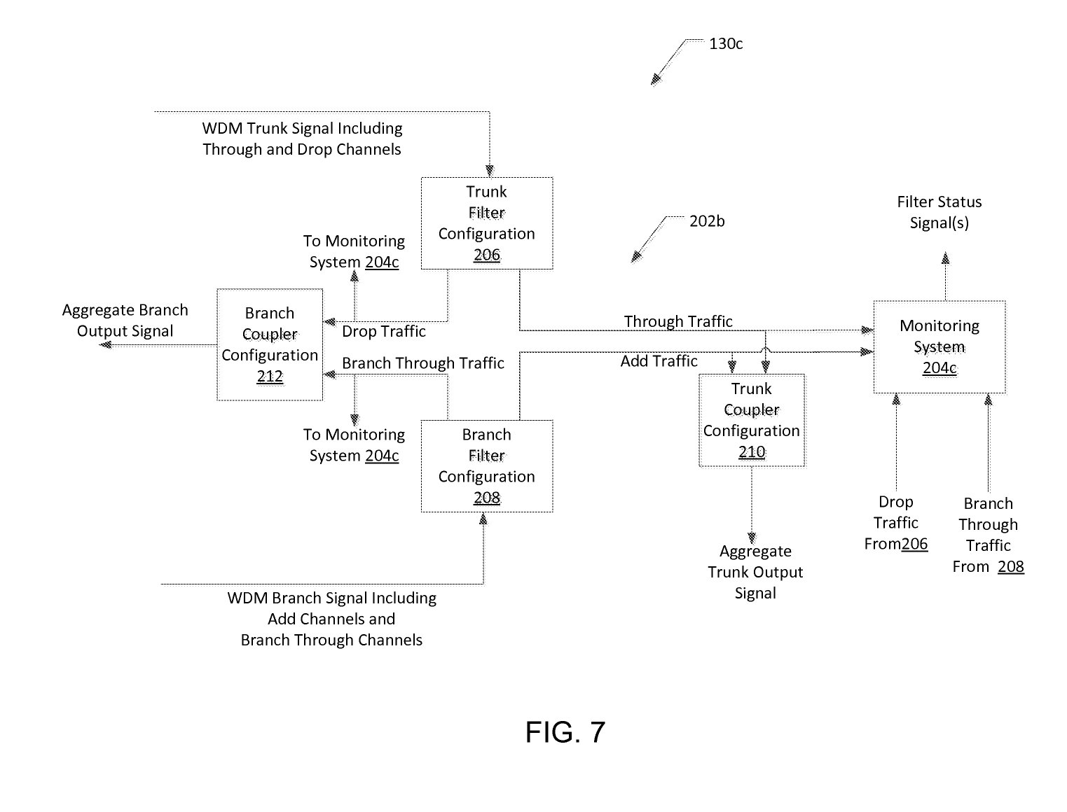

FIG. 7 illustrates another embodiment 130c of a branching unit consistent with the present disclosure including an OADM 202b and a monitoring system 204c. The OADM 202b includes a trunk filter configuration 206, a branch filter configuration 208, a trunk coupler configuration 210 and a branch coupler configuration 212. In general, the trunk filter configuration 206, branch filter configuration 208, trunk coupler configuration 210 and branch coupler configuration 212 may be configured and operate as described above in connection with FIG. 2.

In the embodiment 130c of FIG. 7, however, the channels passed onto the through traffic path and the add traffic path are coupled to the monitoring system 204c without being aggregated by the trunk coupler configuration, and the channels passed onto the drop traffic path and the branch through traffic path by the branch coupler configuration 212 are coupled to the monitoring system 204c without being aggregated by the branch coupler configuration 212. The monitoring system 204c in the embodiment illustrated in FIG. 7 may filter the channels passed onto the through traffic path with a through channel filter shape, the channels passed onto the add traffic path with an add channel filter shape, the channels passed onto the drop traffic path with a drop channel filter shape and/or the channels passed on to the branch through traffic path with a branch through filter shape. As described above, the monitoring system 204c illustrated in FIG. 7 may provide one or more filter status signals if the power passing through the add, through, drop and/or branch through filter shapes is different from an associated predetermined amount of optical power to indicate a fault in the trunk 206 or branch 208 filter configurations.

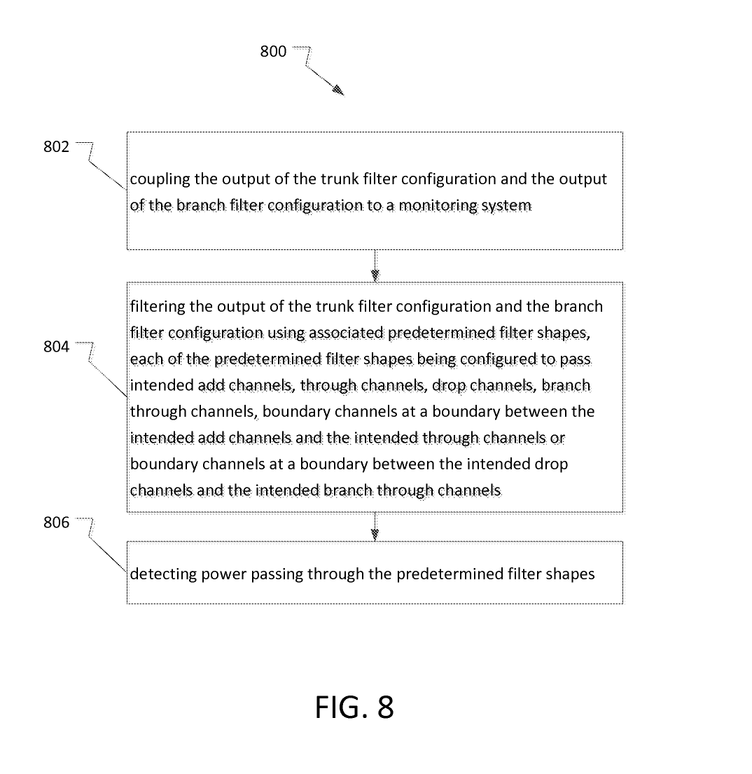

FIG. 8 is a block flow diagram for a method 800 of monitoring trunk and branch filter configurations in an optical add-drop multiplexer consistent with the present disclosure. The illustrated block flow diagram may be shown and described as including a particular sequence of steps. The illustrated sequence of steps in merely provides an example of how the general functionality described herein can be implemented. The steps do not have to be executed in the order presented unless otherwise indicated. In addition, it is to be understood that other embodiments consistent with the present disclosure may include sub-combinations of the illustrated steps and/or additional steps described herein. Thus, claims presented herein may be directed to all or part of the components and/or operations depicted in one or more figures.

The illustrated embodiment includes coupling 802 the output of the trunk filter configuration and the output of the branch filter configuration to a monitoring system. The outputs of the trunk filter configuration and the branch filter configuration are filtered 804 using associated predetermined filter shapes. Each of the predetermined filter shapes is configured to pass intended add channels, through channels, drop channels, branch through channels, boundary channels at a boundary between the intended add channels and the intended through channels or boundary channels at a boundary between the intended drop channels and the intended branch through channels. Power passing through the predetermined filter shapes is detected 806 to identify faults in the filter configurations

According to one aspect of the present disclosure there is provided an optical add-drop multiplexer including a trunk filter configuration configured to receive a wavelength division multiplex (WDM) trunk signal including one or more through channels and one or more drop channels, the trunk filter configuration being nominally configured to pass the through channels onto a through traffic path and the drop channels onto a drop traffic path; a branch filter configuration configured to receive a WDM branch signal including one or more add channels and one or more branch through channels, the branch filter configuration being nominally configured to pass the add channels onto an add traffic path and the branch through channels onto a branch through traffic path; and a monitoring system configured to filter at least one of: the through channels passed onto the through traffic path; the drop channels passed onto the drop traffic path; the add channels passed onto the add traffic path; the branch through channels passed onto the branch through traffic path; boundary channels at a boundary between the add channels and the through channels or boundary channels at a boundary between the drop channels and the branch through channels, using at least one predetermined filter shape, the monitoring system being further configured to detect power in channels passed through the at least one predetermined filter shape.

According to another aspect of the disclosure there is provided an optical add-drop multiplexer including a trunk filter configuration configured to receive a wavelength division multiplex (WDM) trunk signal including one or more through channels and one or more drop channels, the trunk filter configuration being nominally configured to pass the through channels onto a through traffic path and the drop channels onto a drop traffic path; a branch filter configuration configured to receive a WDM branch signal including one or more add channels and one or more branch through channels, the branch filter configuration being nominally configured to pass the add channels onto an add traffic path and the branch through channels onto a branch through traffic path; a trunk coupler configuration coupled to the through traffic path and the add traffic path and configured to combine channels on the through traffic path and the add traffic path into an aggregate trunk output signal; a branch coupler configuration coupled to the branch through traffic path and the drop traffic path and configured to combine channels on the branch through traffic path and the drop traffic path into an aggregate branch output signal; and a monitoring system configured to filter at least one of a trunk monitor signal representative of the aggregate trunk output signal and a branch monitor signal representative of the aggregate branch output signal using a plurality of predetermined filter shapes, each of the plurality of predetermined filter shapes being configured to pass the add channels, the through channels, the drop channels, the branch through channels, boundary channels at a boundary between the add channels and through channels or boundary channels at a boundary between the drop channels and the branch through channels, the monitoring system being further configured to detect power in channels passed through the plurality of predetermined filter shapes.

According to another aspect of the disclosure there is provided a method of monitoring trunk and branch filter configurations in an optical add-drop multiplexer, the method including: coupling the output of the trunk filter configuration and the output of the branch filter configuration to a monitoring system; filtering the output of the trunk filter configuration and the branch filter configuration using associated predetermined filter shapes, each of the predetermined filter shapes being configured to pass intended add channels, through channels, drop channels, branch through channels, boundary channels at a boundary between the intended add channels and the intended through channels or boundary channels at a boundary between the intended drop channels and the intended branch through channels; and detecting power passing through the predetermined filter shapes.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Elements, components, modules, and/or parts thereof that are described and/or otherwise portrayed through the figures to communicate with, be associated with, and/or be based on, something else, may be understood to so communicate, be associated with, and/or be based on in a direct and/or indirect manner, unless otherwise stipulated herein.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

While the principles of the invention have been described herein, it is to be understood by those skilled in the art that this description is made only by way of example and not as a limitation as to the scope of the invention. Other embodiments are contemplated within the scope of the present invention in addition to the embodiments shown and described herein. Modifications and substitutions by one of ordinary skill in the art are considered to be within the scope of the present invention, which is not to be limited except by the following claims.

What is claimed is:

1. An optical add-drop multiplexer, comprising:
a trunk filter configuration configured to receive a wavelength division multiplex (WDM) trunk signal comprising one or more through channels and one or more drop channels, the trunk filter configuration being nominally configured to pass the through channels onto a through traffic path and the drop channels onto a drop traffic path;
a branch filter configuration configured to receive a WDM branch signal comprising one or more add channels and one or more branch through channels, the branch filter configuration being nominally configured to pass the add channels onto an add traffic path and the branch through channels onto a branch through traffic path; and
a monitoring system configured to filter at least one of: the through channels passed onto the through traffic path; the drop channels passed onto the drop traffic path; the add channels passed onto the add traffic path; the branch through channels passed onto the branch through traffic path; boundary channels at a boundary between the add channels and the through channels or boundary channels at a boundary between the drop channels and the branch through channels, using at least one predetermined filter shape, the monitoring system being further configured to detect power in channels passed through the at least one predetermined filter shape.

2. The optical add-drop multiplexer of claim 1, wherein the at least one predetermined filter shape comprises an add channel filter shape configured to pass the add channels and a through channel filter shape configured to pass the through channels, and wherein the monitoring system is configured to filter the add channels passed onto the add traffic path using the add channel filter shape and the through channels passed onto the through traffic path using the through channel filter shape.

3. The optical add-drop multiplexer of claim 2, further comprising a trunk coupler configuration coupled to the through traffic path and the add traffic path and configured to combine channels on the through traffic path and the add traffic path into an aggregate trunk output signal, wherein a trunk monitor signal representative of the aggregate trunk output signal is coupled to the monitoring system.

4. The optical add-drop multiplexer of claim 1, wherein the at least one predetermined filter shape comprises an drop channel filter shape configured to pass the drop channels and a branch through channel filter shape configured to pass the branch through channels, and wherein the monitoring system is configured to filter the drop channels passed onto the drop traffic path using the drop channel filter shape and the branch through channels passed onto the branch through traffic path using the branch through channel filter shape.

5. The optical add-drop multiplexer of claim 4, further comprising a branch coupler configuration coupled to the branch through traffic path and the drop traffic path and configured to combine channels on the branch through traffic path and the drop traffic path into an aggregate branch output signal, wherein a branch monitor signal representative of the aggregate branch output signal is coupled to the monitoring system.

6. The optical add-drop multiplexer of claim 1, the monitoring system being further configured to provide at least one filter status signal indicating a fault in the trunk filter configuration or the branch filter configuration if the power in channels passed through the at least one predetermined filter shape is different from an associated predetermined expected amount of optical power.

7. The optical add-drop multiplexer of claim 6, further comprising a redundant trunk filter configuration and a switch configured to switch the WDM trunk signal from the trunk filter configuration to the redundant trunk filter configuration in response to the at least one filter status signal.

8. The optical add-drop multiplexer of claim 1, wherein the at least one predetermined filter shape comprises a first boundary channel filter shape configured to pass the boundary channels at the boundary between the add channels and the through channels and a second boundary channel filter shape configured to pass the boundary channels at the boundary between the drop channels and the branch through channels.

9. An optical add-drop multiplexer, comprising:
a trunk filter configuration configured to receive a wavelength division multiplex (WDM) trunk signal comprising one or more through channels and one or more drop channels, the trunk filter configuration being nominally configured to pass the through channels onto a through traffic path and the drop channels onto a drop traffic path;
a branch filter configuration configured to receive a WDM branch signal comprising one or more add channels and one or more branch through channels, the branch filter configuration being nominally configured to pass the add channels onto an add traffic path and the branch through channels onto a branch through traffic path;
a trunk coupler configuration coupled to the through traffic path and the add traffic path and configured to combine channels on the through traffic path and the add traffic path into an aggregate trunk output signal;
a branch coupler configuration coupled to the branch through traffic path and the drop traffic path and configured to combine channels on the branch through traffic path and the drop traffic path into an aggregate branch output signal; and
a monitoring system configured to filter at least one of a trunk monitor signal representative of the aggregate trunk output signal and a branch monitor signal representative of the aggregate branch output signal using a plurality of predetermined filter shapes, each of the plurality of predetermined filter shapes being configured to pass the add channels, the through channels, the drop channels, the branch through channels, boundary channels at a boundary between the add channels and through channels or boundary channels at a boundary between the drop channels and the branch through channels, the monitoring system being further configured to detect power in channels passed through the plurality of predetermined filter shapes.

10. The optical add-drop multiplexer of claim 9, wherein the plurality of predetermined filter shapes comprises an add channel filter shape configured to pass the add channels, a through channel filter shape configured to pass the through channels, a drop channel filter shape configured to pass the drop channels and a branch through filter shape configured to pass the branch through channels, and wherein the monitoring system is configured to filter the trunk monitor signal using the add channel filter shape and the through channel filter shape and to filter the branch monitor signal using the drop channel filter shape and the branch through filter shape.

11. The optical add-drop multiplexer of claim 9, the monitoring system being further configured to provide at least one filter status signal indicating a fault in the trunk filter configuration or the branch filter configuration if the power in the channels passed through at least one of the plurality of predetermined filter shapes is different from an associated predetermined expected amount of optical power.

12. The optical add-drop multiplexer of claim 11, further comprising a redundant trunk filter configuration and a switch configured to switch the WDM trunk signal from the trunk filter configuration to the redundant trunk filter configuration in response to the at least one filter status signal.

13. The optical add-drop multiplexer of claim 9, wherein the plurality of predetermined filter shapes comprises at least one first boundary channel filter shape configured to pass the boundary channels at the boundary between the add channels and through channels and at least one second boundary channel filter shape configured to pass the boundary channels at the boundary between the drop channels and the branch through channels.

14. A method of monitoring trunk and branch filter configurations in an optical add-drop multiplexer, the method comprising:
coupling the output of the trunk filter configuration and the output of the branch filter configuration to a monitoring system;
filtering the output of the trunk filter configuration and the branch filter configuration using associated predetermined filter shapes, each of the predetermined filter shapes being configured to pass intended add channels, through channels, drop channels, branch through channels, boundary channels at a boundary between the intended add channels and the intended through channels or boundary channels at a boundary between the intended drop channels and the intended branch through channels; and
detecting power passing through the predetermined filter shapes.

15. The method of claim 14, wherein coupling the output of the trunk filter configuration and the output of the branch filter configuration to a monitoring system comprises aggregating the output of the trunk filter configuration and the output of the branch filter configuration to provide a monitor signal and coupling the monitor signal to the monitoring system

16. The method of claim 14, the method further comprising providing at least one filter status signal indicating a fault in the trunk filter configuration or the branch filter configuration if the power passing through the predetermined filter shapes is different from a predetermined expected amount of optical power.

17. The method of claim 14, wherein the predetermined filter shapes comprises a first boundary channel filter shape configured to pass the boundary channels at the boundary between the intended add channels and the intended through channels and a second boundary channel filter shape configured to pass boundary channels at the boundary between the intended drop channels and the intended branch through channels.
